(19) United States
(12) Patent Application Publication
(10) Pub. No.: US 2018/0274487 A1
(43) Pub. Date: Sep. 27, 2018

(54) Induction ignition device for initiating a fuel burn

(71) Applicants: David Summers, Chicago, IL (US); Michael J. Malloy, NE Canton, OH (US)

(72) Inventors: David Summers, Chicago, IL (US); Michael J. Malloy, NE Canton, OH (US)

(21) Appl. No.: 15/468,313

(22) Filed: Mar. 24, 2017

(51) Int. Cl. F02K 9/95; F02K 9/08; F02K 9/97; H02J 50/10; F23Q 13/00

(52) U.S. Cl. CPC F02K 9/95; F02K 9/08; F23Q 13/00; H02J 50/10; F02K 9/97

(57) ABSTRACT

An ignition device for initiating a fuel burn includes a fuel mass, wherein the fuel mass has a target body disposed therein to be heated, and a heating element, where the heating element provides an alternating magnetic field about the target body upon activation thereof to cause the target body to heat sufficiently to initiate during of at least a part of the fuel mass adjacent the target body.

### BACKGROUND OF INVENTION

### Field of Invention

The present invention relates generally to an induction ignition device for initiating a fuel burn. More particularly, the invention relates to an apparatus and method for fueling a rocket with a solid propellant, igniting solid or liquid propellant, and to a rocket engine fueled by a solid propellant as well as to a rocket fuel structure using an induction process.

### Related Art

The use of electricity in firing rockets has also presented several drawbacks. Due to the necessity for leading ignition wires from the interior of a rocket motor to a connector on the launching apparatus, it becomes difficult to effectively seal the rocket motor against the entry of air or moisture both of which are harmful to the propellant charge. Moreover, time-consuming delays are often encountered in making the proper electrical connections and in addition positive operation is rendered uncertain due to the occasional accidental grounding of the lead wires.

Rocket engines fueled by a solid propellant, so-called solid fuel rockets, commonly have a fuel housing within which is one or more bodies of combustible solid that is ignited to drive hot gasses from a rearwardly directed nozzle. Once the combustible solid fuel is ignited, it generally must burn completely without the possibility of shut down or control. Regulation of the burn rate is accomplished by providing different fuel formulas and surface areas at different locations within the housing. In flight regulation is not possible.

The propellant in rocket engines is difficult to reliably ignite. In order to ignite the propellant, a physical connection from the inside of the combustion chamber to the outside control system is required. This physical connection is unreliable, and rocket engine ignition failures are very common. Ignition is made even more difficult if the propellant must be moved into the combustion chamber, as any wiring to the propellant grain must now pass into the chamber as well. Additionally, much of the difficulty of launching small model rockets is in installing the igniters, which have high failure rates. Simple model rockets would appeal to a wider audience if igniters were simpler and more reliable.

On a larger scale, rockets are currently extremely expensive to operate, limiting their applications to specialized fields such as space and orbital work. A much larger market can be realized if a rocket's operational cost can be lowered. For example, a small aircraft capable of flying people from Chicago to Beijing in 45 minutes would appeal to a large market if available at reasonable costs.

Rocket's costs are primarily related to complexity and size. The smaller a rocket, the less it costs to develop and fly. This is due largely to a decrease in complexity, but also due to a decrease in the “worst case” disaster severity—the safety requirements for a 747 are much larger than those of a Cessna two-seater.

As complexity increases cost increases exponentially, as each part needs to be designed, tested, and maintained. In addition, each part is interrelated to all the other parts. If the heat shielding is too massive, you need more propellant, which cascades to larger engines, bigger wings, etc. leading to a still larger heat shield. So, in addition to a lower parts count, the parts should be less interrelated to achieve lower costs. Solid rockets are by far the simplest forms of rockets. They do not require finely tuned injectors, propellant mixing, pumping, storage and movement in tanks, hard starts, etc.

Historically, solid rockets have been held back by their lower performance—primarily due to the entire propellant supply being necessarily contained inside the engine itself. Solid rockets typically also have lower Isp (specific impulse—a measure of engine propellant efficiency) than liquid propellants, and therefore require higher mass fractions to achieve the same total impulse.

Making a rocket that can achieve a large change in velocity is very difficult. The basic governing equation is v=Isp·9.8·In(MR); where v is the change in velocity, Isp is a measure of the rocket engine's thrust performance, and MR is the mass ratio (full stage mass divided by the empty stage mass). Rockets typically have an Isp between 300 and 450 seconds, and a mass ratio of about 10. Unfortunately, higher Isp engines tend to have lower mass ratios—so achieving a stage velocity change of 9,000 m/s or more has been difficult to achieve. Maximum Isp is limited primarily by available energy in the fuel, and so is difficult to increase.

A solid fuel feeder increases stage velocity by allowing extremely high mass ratio stages, instead of focusing on Isp. Essentially, stage mass ratio is governed by two things: the engine's thrust to weight ratio, and the tank mass fraction. Rocket engines inherently have large thrust ratios—but the tank mass fraction is difficult to make acceptable. The tanks must typically hold cryogenic fuels, which limits the materials that can be used while building them. The highest Isp fuels have low density, and so require larger tanks volumes for a given mass. Third, most rocket engines require high inlet pressures, so the tanks must hold high pressures.

Making these tanks lightweight virtually requires low design margins. This makes them very fragile—if they are taken just a little off optimum, they rupture. When they rupture, the high internal pressure forces the fuel out of the tank and into the surrounding area. Typically, this force (and the rocket engine burning below it) ignites the propellant and destroys the rocket and anything nearby.

Obviously, this is not acceptable. Because all these variables are interdependent, a solution is extremely hard to find. As the design misses its mass targets, an increase must be made in the propellant load, which requires increased engine mass and which requires yet more fuel, and increased tank mass which requires larger and heavier heat shields, and heavier structure. These interdependencies make large delta-v vehicle designs very risky, and small subsystem performance prediction errors cause large vehicle performance misses.

Fireworks and hobby rockets compose another, closer term market. In both of those markets, the rocket motors used to lift payloads to low altitudes share the reliability problem of larger rockets. It is exacerbated by the need to keep costs low, resulting in using dangerous fuses in firework mortars, and unreliable and difficult to use electric resistance igniters in hobby rockets.

The present invention overcomes the above mentioned problems. But in the electro-magnetic induction system of the present invention, the necessity for ignition lead wires is eliminated. Positive ignition of a rocket motor is brought about by a secondary coil positioned outside a sealed propellant chamber, the electrical current necessary for such secondary launching apparatus remaining outside the combustion chamber.

### SUMMARY OF INVENTION

It is an object to improve rockets.

Another object is to improve rocket design and fuel ignition.

A further object is to provide an induction heated element for ignition, increasing reliability by not requiring assembly of the ignition system and increasing safety by allowing firework mortars to be easily ignited inside a mortar tube.

Still another object is to decrease cost of rockets.

It is a still further object of this invention to provide a safe electrical ignition system for firing rocket projectiles. That is to say, a system whereby the rocket projectile must first be placed into proper firing position within or on a launching apparatus before ignition can be brought about.

A further object is to provide a safer rocket.

Accordingly, the invention is directed to an ignition device for initiating a fuel burn which includes a fuel mass, wherein the fuel mass has a target body disposed therein to be heated, and a heating element, where the heating element provides an alternating magnetic field about the target body upon activation thereof to cause the target body to heat sufficiently to initiate during of at least a part of the fuel mass adjacent the target body.

The specific nature of the invention as well as other objects and advantages thereof will clearly appear from a description of a preferred embodiment as shown in the accompanying drawings.

### BRIEF DESCRIPTION OF THE DRAWINGS

FIG. 1 shows side sectional a rocket engine with an ignition element therein.

FIG. 2 shows perspective view the rocket engine of FIG. 1.

FIG. 3 shows a side view of an external induction rocket launch mode.

FIG. 4 shows an induction circuit schematic for the invention.

FIG. 5 shows a side sectional view another embodiment of a fuel grain of the invention.

FIG. 6 shows a perspective view of the fuel grain of FIG. 5.

FIG. 7 shows a side view another embodiment of an engine of the invention.

FIG. 8 shows a side view of the engine of FIG. 7.

FIG. 9 shows another side view of the engine of FIG. 7.

### DETAILED DESCRIPTION OF PREFERRED EMBODIMENTS

It is possible to avoid all of the aforementioned problems of the prior designs by using a solid propellant in a rocket engine, and in one embodiment injected into the rocket engine. No tank is required with the instant invention, a solid or liquid fuel mass and preferably a solid fuel can serve as its own tank. This means that the mass ratio can be practically as high as the engine thrust ratio. Solid fuels are not typically cryogenic, so they require no special handling or materials. Because the solid fuel is not pressurized at all, there is no equivalent to a tank rupture. The fuel can (and should) be designed to not burn well at atmospheric pressure and thus a worst case crash or failure means a slowly burning rope-like mass slumps to the ground. Refueling with a solid fuel is also faster than with liquid fuels. Instead of transferring fuels between containers, the fuel end can be disposed adjacent a holding area.

The following illustrates the problem mass ratio poses during launch vehicle design. The rocket's performance can be defined as:

delta-v=Isp·In(1+Mₚᵣₒₚₑₗₗₐₙₜ/[M_{engine}+Mₜₐₙₖₛ+M_{heatshield}+M_{structure}+M_{fixed}+M_{payload}+Mₚᵣₒₚₑₗₗₐₙₜ])

Where:

M_{engine}=Thrust To Weight Ratio·[M_{engine}+Mₜₐₙₖₛ+M_{heatshield}+M_{structure}+M_{fixed}+M_{payload}+Mₚᵣₒₚₑₗₗₐₙₜ]

Mₜₐₙₖₛ=F(Isp, Mₚᵣₒₚₑₗₗₐₙₜ)

M_{heatshield}=F(Tank Size)

A high delta-v rocketry requires optimization of the “rocket equation”:

Delta-v=Isp*g*In(M_{final}/Mᵢₙᵢₜᵢₐₗ)

The interdependencies in vehicle design can be diminished using the instant invention. Adding propellant only requires a larger engine. Since there is no tank, the heat shield design can remain unchanged. If the propellant is self supporting (or is hanging in the rear of the vehicle), no additional structure is needed for the extra propellant loads. This makes vehicle design far easier, and makes the minimum vehicle scale far smaller as well.

As the propellant largely determines the Isp, a high mass fraction is desirable in a rocket. Solid rockets inherently have higher density propellant, and do not require high pressure tanks to prevent cavitation in pumps and injectors. In typical solid motors, this is offset by the requirement to store the entire propellant load inside the engine.

The present invention allows the propellant grains to be stored outside the engine, and only inserted when ready to fire. This allows much higher mass fractions, while greatly improving safety as well. Safety is improved by use of the invention. The engine chamber can be much smaller, limiting the energy released in a rupture. The propellant grains can be made to resist burning outside the engine chamber. Also, the propellant cannot spill, spray and spread as a liquid does.

An igniter operates by having a target body (in the preferred case a short, thin steel rod) in close proximity to the propellant. An accelerant may be used to help initiate the reaction more quickly, or with lower power. A coil surrounds (or is near) the target body, and when current flows through the coil an alternating magnetic field heats the target body. There are other methods of creating the alternating magnetic field as known to those skilled in the art. As the induction target can be a short piece of iron wire, it is far cheaper than an electric ignitor and is less expensive than a fuse.

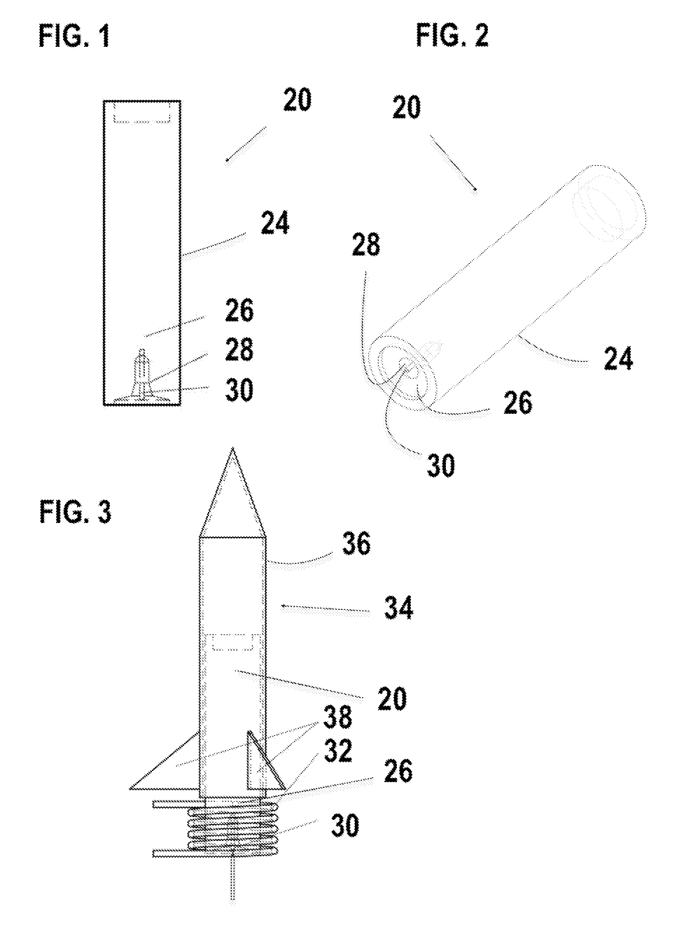

Referring now to the drawings, an external ignition system of an embodiment of the invention is generally referred to by the numeral 10. FIG. 1 shows a rocket motor 20. The rocket engine 20 includes a housing 24, propellant 26, engine throat 28 and ignitor steel rod 30 or other metal coated, (e.g. iron coated) element. In the embodiment, the housing 24 can be generally cylindrical. An induction coil 32 can be configured to movably receive an end 25 of housing 24 having the engine throat 28 of propellant 26 therein which contains the ignitor steel rod 30. In the preferred embodiment, steel rod 30 is embedded in the propellant 26 as seen in FIG. 2. Alternately, to simplify manufacture of rocket engine 20, it may be preferential to have the steel rod attached to the induction coil 32 with the propellant 26 merely resting on top of it as seen in FIG. 3.

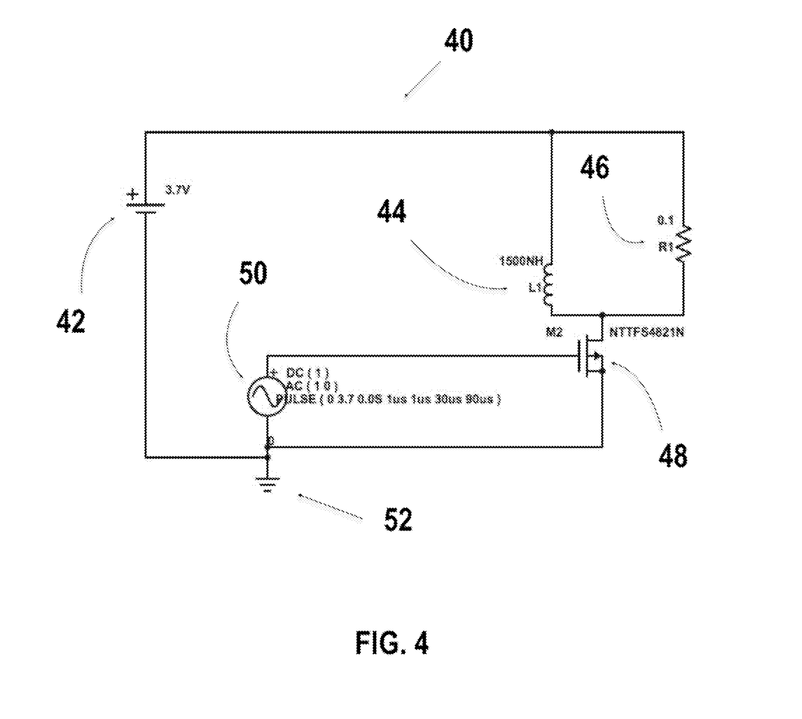

A rocket vehicle 34 includes rocket housing body 36 which is configured to receive at least part of the rocket engine 20 therein. The rocket housing body 36 can preferably include a plurality of fins 38. As seen in FIG. 4, the ignition can be controlled by an induction circuit 40 as depicted in FIG. 4. Induction circuit 40 provides from ground 52 a DC voltage source 42, e.g. 3.7V, coupled to an inductor 44 and resistor 46 which are in parallel. These in turn connect in series to a metal-oxide-semiconductor field-effect transistor (MOSFET) 48 such as NTTFS4821N which in turn is connected to an AC power source 50 leading to ground 52. An exemplary circuit can include a 3.7 V Battery as a power source.

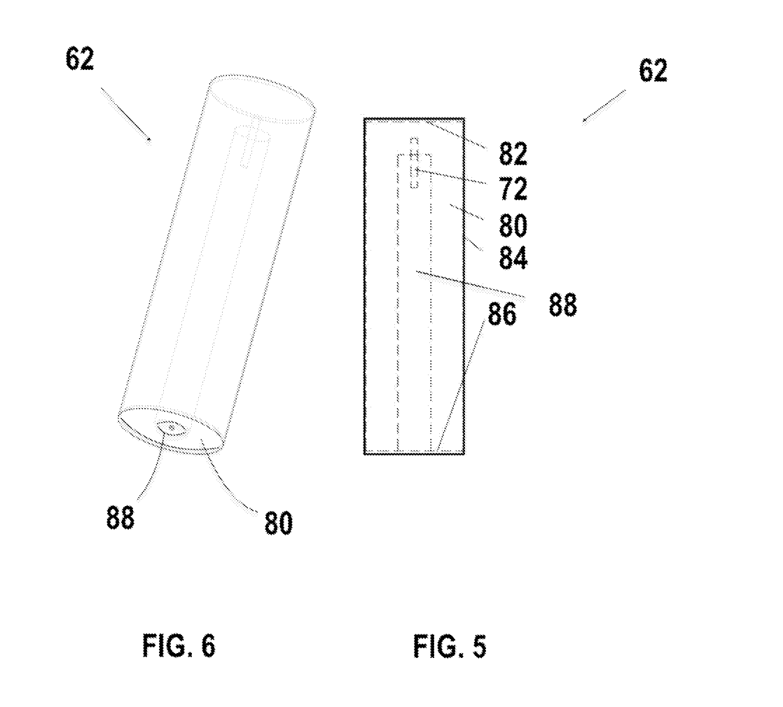

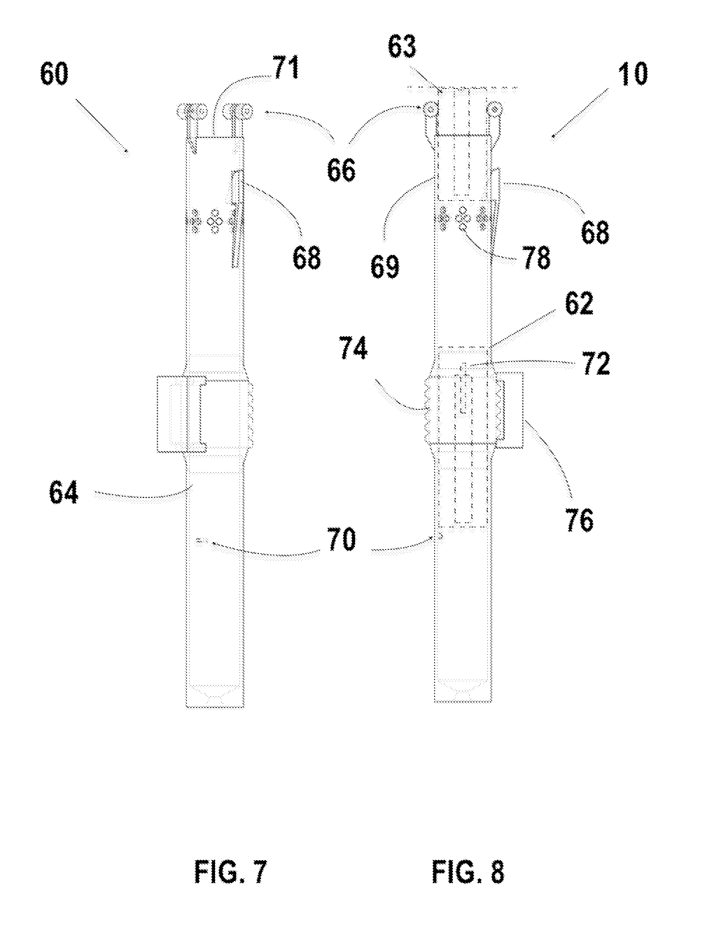

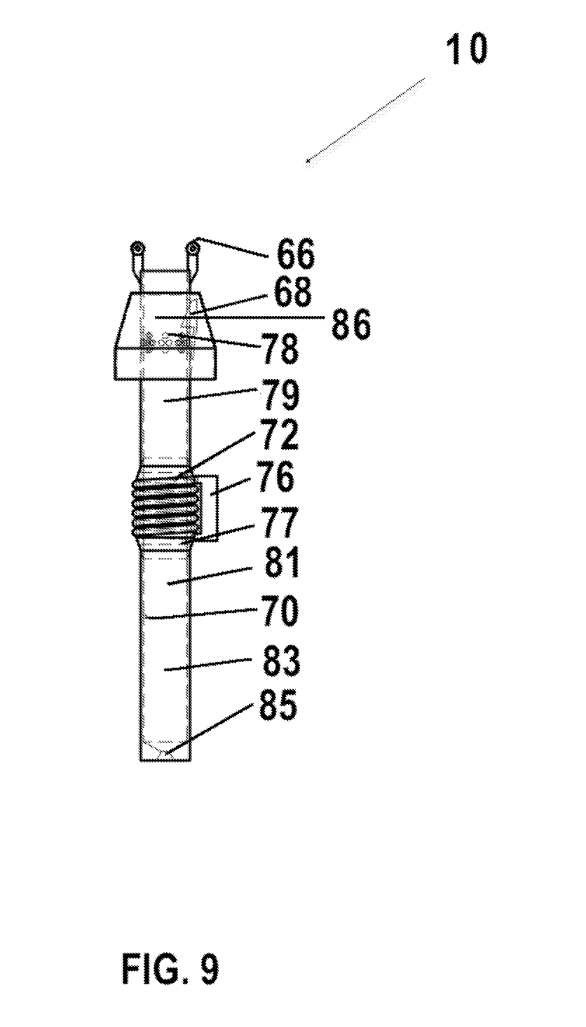

In another preferred embodiment, FIG. 5-8, there is provided another engine 60 for receiving a fuel grain 62. The engine 60 operates by having fuel grain 62 pushed into an engine chamber 64 by the injector tractor 66 (or some other way as known to those skilled in the art).

The fuel grain 62 includes an ignitor steel rod 72 (target body) inside of a propellant 80 which is contained by a casing top 82, casing side 84 and casing bottom 86. The propellant 80 includes a combustion chamber 88 into which the ignitor rod 72 extends.

Immediately following that grain 62, another grain 63 or mock grain is loaded by the injector tractor 66 until it is past a latching mechanism 68 within an injection tube 69 into a blocking grain holding area 79 wherein the latching mechanism 68 permits the grains 62 one way passage thereby.

A stop 70 inside the engine 60 prevents the grain 62 from going too far in, stopping it when the target body 72 inside the grain 62 is inside coils 74 of an induction circuit 76 which is retained by a coil holder 77. The loaded grain 62 rests in a combustion grain holding area 81 and an optional combustion chamber extension 83 remains below the grain stop 70 to increase mixing time for more complete combustion. The induction coil 74 provides a large alternating magnetic field, which heats the target body 72. The target body 72 then ignites the grain 62 and exhaust passes through nozzle 85. Optionally, it is contemplated an accelerant can be provided to more quickly ignite the grain 62.

As the grain 62 burns, a second grain 63 or mock grain adjacent the burning grain 62 is engaged by the latch mechanism causing the grain 63 to flex and seal injection hole 71 and prevents most of the hot gasses produced from flowing out of the injection tube 69. This effect is enhanced by having the latch 68 only engage the grain 62 on one side, which skews the slightly flexible grain 62 to more completely plug the injection hole 71. Some gases that bypass the grain 62 are extracted by vent holes 78, and redirected to the rear to provide additional thrust with a flow redirect housing 86 disposed about the vent holes 78.

In rocketry, one of the more difficult aspects of operation is reliable ignition of the propellant. By utilizing induction heating of an element of the present invention, there is provided a reliable ignition of rocket propellant. In addition, as no external connection to the propellant is required solid propellant systems using this invention can be much safer, as the propellant can be entirely sealed in a case. In this case, the propellant will not accidentally ignite until the extreme magnetic fluctuations caused by the induction heater are present.

While the invention has been described with particularity in reference to the several embodiments disclosed which produce satisfactory results, it will be apparent to those skilled in the art to which the invention pertains after understanding the invention, that the invention in its broader aspect could be carried out by other instrumentalities, and it is understood that the terms used in the claims are words of description and not of limitation except as necessitated by the prior art. Modifications, derivations and variations of the present invention are possible in the light of the above teachings. It is therefore to be understood that within the scope of the appended claims the invention may be practiced otherwise than as specifically described.

What is claimed is:

1. An ignition device for initiating a fuel burn comprising:
a fuel mass, wherein said fuel mass has a target body disposed therein to be heated, and a heating element, where said heating element provides an alternating magnetic field about said target body upon activation thereof to cause said target body to heat sufficiently to initiate during of at least a part of said fuel mass adjacent said target body.

2. The ignition device of claim 1, wherein said fuel mass includes one of a solid form and liquid form.

3. The ignition device of claim 2, wherein said fuel mass includes an ignition chamber and said target body extends into said ignition chamber.

4. The ignition device of claim 1, which further includes an induction coil configured to about said fuel mass in a manner to retain said target body within said induction coil.

5. The ignition device of claim 1, which includes a housing containing said fuel mass to maintain said target body in a fixed relation to said heating element.

6. The ignition device of claim 5, wherein said heating element includes an induction coil connected to said housing and said target body includes a metal wire.

7. The ignition device of claim 1, which includes a rocket housing containing said fuel mass to maintain said target body in a fixed relation to said heating element.

8. The ignition device of claim 7, wherein said heating element includes an induction coil connected to said housing and said target body includes a metal wire.

9. The ignition device of claim 5, wherein said housing includes restricted orifice through which exhaust of burned fuel mass causing propulsion.

10. The ignition device of claim 7, wherein said rocket housing includes restricted orifice through which exhaust of burned fuel mass causing propulsion.

11. The ignition device of claim 5, wherein said housing is disposed within a rocket.

12. The ignition device of claim 1, wherein said heating element is part of a launch pad which is operably connected thereto.

13. The ignition device of claim 4, wherein said induction coil is part of a launch pad.

14. The ignition device of claim 1, further comprising an accelerant with said fuel mass.

15. The ignition device of claim 5, wherein said fuel mass includes a plurality of propellant grains within said housing in a manner to burn in succession.

16. The ignition device of claim 7, wherein said fuel mass includes a plurality of propellant grains within said rocket housing in a manner to burn in succession.

17. The ignition device of claim 15, wherein said housing further comprising a latch to permit said grains one way passage thereby.

18. The ignition device of claim 16, wherein said rocket housing further comprising a latch to permit said grains one way passage thereby.

19. The ignition device of claim 17, wherein said latch engages one of said grains to generally block passage within said housing.

20. The ignition device of claim 18, wherein said latch engages one of said grains to generally block passage within said rocket housing.

21. The ignition device of claim 15, further comprising a tractor to inject said propellant grains into said housing in succession.

22. The ignition device of claim 16, further comprising a tractor to inject said propellant grains into said rocket housing in succession.

23. The ignition device of claim 5, further comprising a stop to prevent said fuel mass from traveling within said housing.

24. The ignition device of claim 7, further comprising a stop to prevent said fuel mass from traveling within said housing.

25. The ignition device of claim 5, further comprising vents serving as primary exits to allow reduced backflow gases to exit said housing in a controlled manner.

26. The ignition device of claim 7, further comprising vents serving as primary exits to allow reduced backflow gases to exit said housing in a controlled manner.

27. The ignition device of claim 25, wherein said vents in said housing direct said backflow towards toward an orifice to provide thrust.

28. The ignition device of claim 26, wherein said vents in said rocket housing direct said backflow towards toward an orifice to provide thrust.
